(19) United States
(12) Patent Application Publication
(10) Pub. No.: US 2012/0207945 A1
(43) Pub. Date: Aug. 16, 2012

(54) PHOTOCURABLE INKS WITH ALDEHYDES AND METHODS OF USE

(76) Inventor: Deepak Shukla, Webster, NY (US)

(21) Appl. No.: 13/026,380

(22) Filed: Feb. 14, 2011

(51) Int. Cl. C09D 11/10; B05D 5/06; B05D 7/24; B05D 3/06; C08K 5/527; C08J 3/28

(52) U.S. Cl. 427/532; 522/76; 522/40; 522/39; 522/33; 522/64; 522/65; 522/66; 522/68; 522/16; 522/12; 522/23; 427/457

(57) ABSTRACT

A photocurable ink contains a colorant dissolved or dispersed within a solvent, a photoinitiator, an organic phosphite, an aldehyde, and a photocurable compound. The organic phosphite is present in a molar excess relative to the aldehyde moieties that are present. The photocurable ink can be used for imaging or other applications where a uniform or patterned image is desired. The photocurable ink can be cured partially before application, or totally cured after application.

### FIELD OF THE INVENTION

This invention relates to photocurable compositions that can be used as photocurable inks containing photocurable compounds. In particular, the photocurable inks can be used and cured in the presence of oxygen.

### BACKGROUND OF THE INVENTION

Natural and synthetic polymers have served essential needs in society. However, in recent times synthetic polymers have played an increasingly greater role, particularly since the beginning of the 20th century. Such synthetic polymers are commonly prepared by an addition polymerization mechanism, that is, free radical chain polymerization of unsaturated monomers. The majority of commercially significant processes are based on free-radical chemistry, or chain polymerization that is initiated by a reactive species, which often is a free radical. The source of the free radicals is termed an initiator or photoinitiator.

Photochemically induced polymerization reactions have become of great importance in industry, in particular for rapid curing of thin films, such as, for example, in the curing of paint coatings and plastic coatings on paper, wood, metal, and plastic or in the drying of printing inks. This curing by irradiation in the presence of photoinitiators is distinguished, compared with conventional methods for the drying or curing of coatings, by saving of materials and energy, low thermal stress of the substrate, and in particular a high curing rate. Moreover, the preparation of polymer materials by polymerization of the corresponding unsaturated monomeric starting materials is often carried out photochemically and by means of photoinitiators in such conventional processes as solution and emulsion polymerization. Since in the reactions mentioned, none of the reactants is usually capable of absorbing a sufficient amount of the photochemically active radiation, it is necessary to add photoinitiators.

Improvements in free radical chain polymerization have been focused both on the polymer being produced and the photoinitiator. Whether a particular unsaturated monomer can be converted to a polymer requires structural, thermodynamic, and kinetic feasibility. Even when all three properties are present, kinetic feasibility is achieved in many cases only with a specific type of photoinitiator. Moreover, the photoinitiator can have a significant effect on reaction rate, which, in turn, can determine the commercial success or failure of a particular polymerization process or product.

The primary function of a photoinitiator is to generate free radicals when the photoinitiator is irradiated with light of appropriate energy or wavelength. Photoinitiators are classified into “Type I” (or photocleavage) photoinitiators and “Type II” (or H-abstraction) photoinitiators according to the pathways by which the effective initiating radicals are generated.

In contrast to photocleavage photoinitiators that are decomposed by light directly into radicals that are effective in initiating polymerization, Type II photoinitiators require a hydrogen donor, or more generally a source of abstractable hydrogen's in order to generate radicals that are effective in initiating polymerization. The process of H-abstraction is usually a bimolecular reaction requiring the encounter of a photoinitiator and a hydrogen-donor. Any source of abstractable hydrogen's can be useful (for example, any structure that yields a stable radical after H-abstraction may serve as an “H donor”) and such sources include amines, thiols, unsaturated rubbers such as polybutadiene or polyisoprene, and alcohols.

Type I photoinitiators can generate free radical either of the two following mechanisms:

(1) the photoinitiator undergoes excitation by energy absorption with subsequent decomposition into one or more radicals, or

(2) a sensitizer molecule absorbs light and the excited sensitizer then transfers energy to the photoinitiator to generate free radicals.

The basic photochemistry and photophysics of both Type I and Type II photoinitiators have been well studied and utilized industrially in UV curable systems (see for example, Turro, N. J., Modern Molecular Photochemistry, 1991, University Science Books, chapters 7, 10, and 13.).

A number of Type I photoinitiators are commonly used in a variety of photocuring related applications and are commercially available. Among Type I photoinitiators, the hydroxyalkylphenone photoinitiators have proven to be particularly useful. Such photoinitiators include but are not limited to, benzoin ethers, benzil monoketals, dialkoxyacetophenones, hydroxyalkylphenones, and derivatives derived from these classes of compounds. α-Amino arylketones are also commonly used as Type I photoinitiators and are commercially available as are mono-and bis-acylphosphine oxides.

Most known photoinitiators (both Type I and II) have only moderate quantum yields (generally less than 0.5), indicating that the conversion of light radiation to radical formation needs to be made more efficient. The overall efficiency of photocuring process, in addition to overall composition of polymerizable material(s), depends on the quantum yield of radical generation of photoinitiator. To increase the overall efficiency of a photocuring, improvements in photoinitiators, as well as improvements in photoinitiating compositions, are necessary. In some cases, the commercial viability of certain systems can depend on whether a relatively modest improvement, for example, in the 2 to 10 times range, can be achieved. Improving photocuring efficiency is especially critical since with increasing diversification and specialization of processes and products in the area of coating techniques using polymer materials and, more and more frequent requirement of providing tailor-made solutions for these problems, increasingly requires higher and more specific demands on the photoinitiators and photoinitiating compositions. Therefore, in many cases, known photoinitiators do not fulfill, or at least not to an optimum degree, the demand made on them today. In most practical applications major, problems include the need to achieve even maximum (or theoretical) photoinitiator efficiency. These problems arise, for example:

(a) due to inefficient light absorption in pigmented systems,

(b) lack of compatibility with a wide range of binder systems and their reactive components and other modifying additives, or

(c) the storage instability in the dark of the systems containing the photoinitiator and the possible deterioration in the quality of the cured final product, such as yellowing, as a result of unconverted initiator residues and initiator degradation products.

Besides these challenges, there is an additional challenge of free radical photocuring inhibition by the presence of oxygen. Oxygen inhibition has always been a major problem for photocuring of acrylate-containing compositions containing multifunctional acrylate monomers or oligomers using a photoinitiated radical polymerization (for example, see Decker et al., Macromolecules 18 (1985) 1241.). Oxygen inhibition is due to the rapid reaction of carbon centered propagating radicals with oxygen molecules to yield peroxyl radicals. These peroxyl radicals are not as reactive towards carbon-carbon unsaturated double bonds and therefore do not initiate or participate in any photopolymerization reaction. Oxygen inhibition usually leads to premature chain termination that results in incomplete photocuring. Thus, many photocuring processes must be carried out in inert environments (for example, under nitrogen or argon), making such processes more expensive and difficult to use in industrial and laboratory settings.

Various methods have been proposed to overcome oxygen inhibition of photocuring:

(1) Amines that can undergo a rapid peroxidation reaction can be added to consume the dissolved oxygen. However, the presence of amines in acrylate-containing compositions can cause yellowing in the resulting photocured composition, create undesirable odors, and soften the cured composition because of chain transfer reactions. Moreover, the hydroperoxides thus formed will have a detrimental effect on the weathering resistance of the UV-cured composition.

(2) Dissolved oxygen can be converted into its excited singlet state by means of a red light irradiation in the presence of a dye sensitizer. The resulting ¹O₂ radical will be rapidly scavenged by a 1,3-diphenylisobenzofuran molecule to generate a compound (1,2-dibenzoylbenzene) that can work as a photoinitiator (Decker, Makromol. Chem. 180 (1979), p. 2027). However, the photocured composition can become colored, in spite of the photobleaching of the dye, prohibiting this technique for use in various products.

(3) The photoinitiator concentration can be increased to shorten the UV exposure during which atmospheric oxygen diffuses into the cured composition. This technique can also be used in combination with higher radiation intensities. Oxygen inhibition can further be reduced by using high intensity flashes that generate large concentrations of initiator radicals reacting with oxygen, but hydroperoxides are also formed.

(4) Free radical photopolymerization can be carried out under inert conditions (Wight, J. Polym. Sci.: Polym. Lett. Ed. 16 (1978) 121), which is the most efficient way to overcome oxygen inhibition. Nitrogen is typically continuously used to flush the photopolymerizable composition during UV exposure. On an industrial UV-curing line, which cannot be made completely airtight, nitrogen losses can be significant, thus making the process expensive and inefficient. This is an even greater concern if argon is used to provide an inert environment.

Other less common ways of overcoming oxygen inhibition of acrylate photopolymerization include using a wax barrier and performing UV exposure under water. Each of these techniques has disadvantages that have made them less likely for commercial application.

Phosphite stabilizers, for example, hindered neoalkyl phosphite compositions as disclosed in U.S. Pat. No. 5,464,889 (Mahood) exhibit undesirable odors, which make their handling and processing unpleasant and perhaps hazardous. Reducing the odors of phosphites would be an advance in the art for any use. It is clear from this discussion that in photopolymerization technology, there are continuing opportunities for improvements in free radical polymerization processes and photoinitiators. Moreover, there is a need in the art for new, energy-efficient photoinitiator compositions that can be used for use in a variety of polymerization and photocuring processes in the presence of oxygen. The need for highly efficient photoinitiating compositions is particularly acute where absorption of light by the reaction medium may limit the amount of energy available for absorption by the photoinitiators. For example, in the preparation of color filter resists, highly pigmented resists are required for high color quality. With the increase in pigment content, the curing of color resists becomes more difficult. The same is true for the UV-photocurable inks, for example offset printing inks, which also are loaded with pigments. Hence, there is a need for photocurable inks having a higher sensitivity and excellent resolution properties.

### SUMMARY OF THE INVENTION

The present invention provides a photocurable ink comprising a colorant dissolved or dispersed within a solvent, a photoinitiator, an organic phosphite, an aldehyde, and a photocurable compound, wherein the organic phosphite is present in a molar excess relative to the aldehyde moieties in the photocurable ink.

Further, this invention provides a method of applying an ink comprising:

providing the photocurable ink of this invention,

curing the photocurable ink by irradiating it with curing radiation, and

before or during curing, applying the photocurable ink to a substrate.

In some embodiments, the method utilizes a photocurable ink that comprises:

a colorant dispersed within a solvent,

an alkyl or aryl aldehyde having one or two aldehyde moieties per molecule and a molecular weight of less than 500,

an organic phosphite that is represented by the following Structure (I) or (II):

(R′O)₃P (I)

wherein the multiple R′ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or two R′ groups can form a cyclic aliphatic ring or fused ring system,

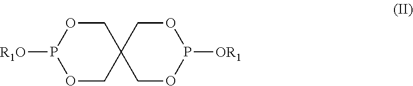

wherein the two R₁ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or the two R₁ groups can form a substituted or unsubstituted cyclic aliphatic ring or fused ring system, and

x is a number at least 2 and up to and including 20, and y is at least 1 and up to and including 20,

a photoinitiator that is one or more of a benzoin, aryl ketone, α-amino ketone, mono- or bis(acyl)phosphine oxide, benzoin alkyl ether, benzil ketal, phenylglyoxalic ester or derivatives thereof, oxime ester, per-ester, ketosulfone, phenylglyoxylate, borate, and metallocene,

a photosensitizer for the photoinitiator that is selected from the group consisting of ketocoumarins, benzophenones, xanthones, thioxanthones, arylketones, and polycyclic aromatic hydrocarbons, and

a photocurable compound that is an acrylate.

The present invention addresses some of the difficulties and problems that are discussed above with energy-efficient photoinitiator compositions that can be used in photocurable inks and in methods of photocuring in various industrial applications. One of the primary advantages of the present invention is that when the photoinitiator composition is combined with polymerizable or photocurable materials in the photocurable ink, it provides more rapid curing times. Moreover, such rapid curing can be achieved in air or in the presence of oxygen as well as in inert environments. Rapid curing in air is particularly advantageous since, as described above, oxygen usually inhibits curing.

The photocurable inks can be used to generate free radical species upon irradiation, for example under extremely low energy lamps, such as excimer lamps and mercury lamps. Further, the photocurable inks can be as much as 200 times faster that the best prior art photocurable compositions.

As noted, when combined with a polymerizable or photocurable compound such as an acrylate, the photoinitiator composition in the photocurable ink causes rapid curing times in comparison to the curing times with photoinitiator alone (without the organic phosphite). It was surprising to me that the use of the organic phosphite used in the photocurable inks of this invention provided unexpectedly better performance in photocuring than use of known Type I or Type II photoinitiators alone, even in the presence of oxygen.

I also found that by incorporating an aldehyde into the photoinitiator composition that curing speed is enhanced even more.

These and other features and advantages of the present invention will become apparent after a review of the following detailed description of the disclosed embodiments and the appended claims.

### DETAILED DESCRIPTION OF THE INVENTION

The photocurable inks of the present invention comprise at least one colorant, at least one wavelength-specific photoinitiator, at least one organic phosphite compound, at least one aldehyde, and a photocurable compound in a suitable solvent. The photocurable inks need no other components that are essential to photoinitiation or the creation of free radicals. However, as noted below, the photocurable inks can optionally include photosensitizers that adjust or sharpen the spectral sensitivity of the photoinitiator to photocuring radiation. Thus, addenda can be present that are not needed for free radical generation but that relate to functions other than photoinitiating. A skilled worker would understand that with routine experimentation, the combination of photoinitiator, organic phosphite, and photocurable compounds can be varied in type and amount of the compounds to optimize the efficacy of photoinitiator ink.

The present invention is useful in methods of polymerizing or photocuring a photocurable compound in the photocurable ink. For example, the photocurable inks can be used with one or more ethylenically unsaturated polymerizable monomers, oligomers, or crosslinkable polymers by exposing the photocurable compounds to suitable radiation in the presence of the photoinitiator.

The photocurable inks of this invention can be used to form films or coatings, textual or pictorial images by providing a mixture of one or more photocurable compounds, photoinitiator, aldehyde, and organic phosphite and irradiating the ink as it is applied or after it is applied to a substrate.

Because the photocuring speeds are high using the present invention, the photocurable inks can be used to advantage because they are dyed or pigmented into which light penetration is limited. It is also possible to use the present invention to rapidly and partially or completely curing of photocurable inks to modify their viscosities.

### Definitions

Unless otherwise indicated, the term “photocurable ink” used in this application will refer to embodiments of the present invention.

The terms “curing”, “photocuring”, and “polymerizing” are used herein to mean the combining for example, by covalent bonding, of large number of smaller molecules, such as monomers or oligomers, to form very large molecules, that is, macromolecules or polymers, when irradiated with radiation such as ultraviolet (UV), visible, or infrared radiation. The monomers can be combined to form only linear macromolecules or they can be combined to form three-dimensional macromolecule, commonly referred to as crosslinked polymers. Thus, these terms include polymerization of functional oligomers and monomers, or even crosslinkable polymers, into a crosslinked polymer network.

The terms “unsaturated monomer,” “functional oligomer,” and “crosslinking agent” are used herein with their usual meanings and are well understood by those having ordinary skill in the art.

The singular form of each component of the photocurable ink is intended also to include the plural that is, one or more of the respective components.

The term “ethylenically unsaturated polymerizable material” is meant to include any unsaturated material having one or more carbon-to-carbon double bonds (ethylenically unsaturated groups) capable of undergoing polymerization. The term encompasses ethylenically unsaturated polymerizable monomers, oligomers, and crosslinkable polymers. The singular form of the term is intended to include the plural. Monofunctional monomers, oligomers, and multifunctional acrylates are examples of unsaturated polymerizable compounds.

As used herein, the term “quantum yield” is used herein to indicate the efficiency of a photochemical process. More particularly, quantum yield is a measure of the probability that a particular molecule will absorb a quantum of light during its interaction with a photon. The term expresses the number of photochemical events per photon absorbed. Thus, quantum yields can vary from zero (no absorption) to 1.

The term “photosensitizer” is meant to refer to a light absorbing compound used to enhance the reaction of a photoinitiator. Upon photoexcitation, a photosensitizer leads to energy or electron transfer to a photoinitiator.

The term photoinitiator refers to a compound that generates free radicals. As noted above, photoinitiators can be classified as “Type I” (or photocleavage) photoinitiators and “Type II” (or H-abstraction) photoinitiators according to the pathways by which the effective initiating radicals are generated.

“Actinic radiation” is any electromagnetic radiation that is capable of producing photochemical action and can have a wavelength of at least 150 nm and up to and including 1250 nm, and typically at least 300 nm and up to and including 750 nm.

### Photocurable Inks

In their most simple form, the energy-efficient photocurable inks of the present invention comprise:

(a) at least one radiation-sensitive photoinitiator that absorbs actinic radiation and therefore produces free radicals,

(b) at least one organic phosphite,

(c) at least one aldehyde,

(d) at least one photocurable compound, and

(e) a colorant dissolved or dispersed in a suitable solvent.

Any organic phosphite is useful in the practice of this invention but particularly useful organic phosphites are represented by the following Structure (I):

(R′O)₃4 (I)

wherein the multiple R′ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or two R′ groups can form a substituted or unsubstituted cyclic aliphatic ring or fused ring system, x is a number at least 2 and up to and including 20, and y is at least I and up to and including 20,

For example, the multiple R′ groups can be the same or different alkyl groups having 1 to 10 carbon atoms or HO[{CH(R)}ₓO]_{y} groups wherein the multiple R groups are hydrogen atoms, x is an integer of at least 2 and up to and including 10, and y is an integer of at least 1 and up to and including 10.

For example, the photocurable ink can comprise one or more of trimethyl phosphite, triethyl phosphite, tripropyl phosphite, tributyl phosphite, triisobutyl phosphite, triamyl phosphite, trihexyl phosphite, trinonyl phosphite, tri-(ethylene glycol)phosphite, tri-(propylene glycol)phosphite, tri(isopropylene glycol)phosphite, tri-(butylene glycol)phosphite, tri-(isobutylene glycol)phosphite, tri-(pentylene glycol)phosphite, tri-(hexylene glycol)phosphite, tri-(nonylene glycol)phosphite, tri-(diethylene glycol)phosphite, tri-(triethylene glycol)phosphite, tri-(polyethylene glycol)phosphite, tri-(polypropylene glycol)phosphite, and tri-(polybutylene glycol)phosphite.

Spiro organic phosphites represented by the following Structure (II) are also useful in the present invention.

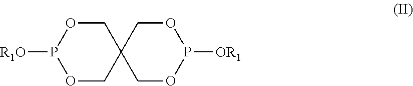

wherein the two R₁ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or the two R₁ groups can form a substituted or unsubstituted cyclic aliphatic ring or fused ring system, x is a number at least 2 and up to and including 20, and y is at least 1 and up to and including 20.

In some embodiments, the photocurable ink includes two or more different organic phosphites.

Any Type I or Type II photoinitiator that generates radicals either upon direct absorption of actinic radiation or by energy transfer from photosensitizers (described below) is useful in present invention. Such photoinitiators include but are not limited to, aryl ketones, such as α-hydroxy ketones, α-amino ketones, and mono- and bis(acyl)phosphine oxides.

Examples of α-hydroxy and α-amino ketones photoinitiators are disclosed for example in U.S. Pat. No. 4,347,111 (Gehlhaus et al.), U.S. Pat. No. 4,321,118 (Felder et al.), U.S. Pat. No. 4,672,079 (Li Bassi et al.), and U.S. Pat. No. 4,987,159 (Li Bassi et al.), and in WO 04/092287 (Fuchs et al.). Some specific examples are 2-hydroxy-2-methyl-1-phenyl-propanone (Darcur® 1173), 1-hydroxy-cyclohexyl-phenyl-ketone (Irgacure® 184), bis[4-(2-hydroxy-2-methylpropionyl)phenyl]methane (Irgacure® 127), 2-hydroxy-1-{4-[4-(2-hydroxy-2-methyl-propionyl)-phenoxy]phenyl}-2-methyl-1-propan-1-one, (1-[4-(2-hydroxyethoxy)-phenyl]-2-10 hydroxy-2-methyl-1-propan-1-one) (Irgacure® 2959), and oligo[2-hydroxy 2-methyl-1-[4(1-methyl)phenyl]propanone (Esacure® KIP 150), which can be obtained from Ciba Specialty Chemicals and Lamberti SpA.

α-Amino ketones, particularly those containing a benzoyl moiety, otherwise called α-amino acetophenones, for example (4-methylthio-benzoyl)-1-methyl-1-morpholinoethane (Irgacure® 907), (4-morpholinobenzoyl)-1-benzyl-1-dimethylaminopropane (Irgacure® 369), (4-morpholinobenzoyl)-1-(4-methylbenzyl)-1-dimethylaminopropane (Irgacure® 379), (4-(2-hydroxyethyl)aminobenzoyl)-1-benzyl-1-dimethylminopropane), 2-benzyl-2-dimethylamino-1-(3,4-dimethoxyphenyl)butan-1-one, and 4-aroyl-1,3-dioxolanes are also useful.

Other useful photoinitiators include benzoin alkyl ethers and benzil ketals, phenylglyoxalic esters and derivatives thereof such as oxo-phenyl-acetic acid 2-(2-hydroxy-ethoxy)-ethyl ester, and dimeric phenylglyoxalic esters such as oxo-phenyl-acetic acid 1-methyl-2-[2-(2-oxo-2-phenyl-acetoxy)-propoxy]-ethyl ester (Irgacure® 754).

Examples of useful oxime ester photoinitiators are disclosed in U.S. Pat. No. 3,558,309 (Laridon et al.), U.S. Pat. No. 4,255,513 (Laridon et al.), U.S. Pat. No. 6,596,445 (Matsumoto et al.), and U.S. Pat. No. 4,202,697 (DeWinter et al.) and in U.S. Patent Application Publication 2010/0188765 (Matsumoto et al.). Some specific examples are 1,2-octanedione 1-[4-(phenylthio)phenyl]-2-(O-benzoyloxime) Irgacure® OXE01), ethanone 1-[9-ethyl-6-(2-methylbenzoyl)-9H-carbazol-3-yl]-1-(O-acetyloxim-e) (Irgacure® OXE02), and 9H-thioxanthene-2-carboxaldehyde 9-oxo-2-(O-acetyloxime).

Per-esters photoinitiators are also useful in present invention. Such compounds include benzophenone tetracarboxylic per-esters as described for example in EP 126,541 (Takeshi et al.).

Examples of useful mono- and bis-acylphosphine oxides are also known from U.S. Pat. No. 4,324,744 (Lechtken et al.), U.S. Pat. No. 4,737,593 (Ellrich et al.), and U.S. Pat. No. 6,020,528 (Leppard et al.), and GB Publication 2,259,704 (Koehler et al.). Some specific examples are 2-4-6-(trimethylbenzoyl)diphenyl-phosphine oxide (Dartocur® TPO), bis(2,4,6-trimethylbenzoyl)-phenyl-phosphine oxide (Irgacure® 819), (2,4,6 trimethylbenzoyl)phenyl phosphinic acid ethyl ester (Lucirin TPO-L® BASF), bis(2,4,6-trimethylbenzoyl)-2,4-dipentoxyphenyl-phosphine oxide, and trisacylphosphine oxides.

Useful ketosulfone photoinitiators are known from WO 00/031030 (Meneguzzo et al.). WO 06/120212 (Romagnano et al.) and U.S. Pat. No. 6,048,660 (Leppard et al.), U.S. Pat. No. 4,475,999 (Via), and U.S. Pat. No. 4,038,164 (Via) describe phenylglyoxylates as photoinitiators. Gottschalk et al. have disclosed borates, associated with ionic dyes, as useful as photoinitiators in U.S. Pat. Nos. 4,772,530, 4,772,541, and 5,151,520. In GB Publication 2,307,474 (Cunningham et al.) have disclosed borates as photoinitiators. Metallocenes such as titanocene-based photoinitiators are in U.S. Pat. No. 5,008,302 (Huesler et al.) and U.S. Pat. No. 5,340,701 (Desobry).

Mixtures of photoinitiators from a single class of compounds, or from two or more different classes of compounds, can be used if desired. The total amount of photoinitiators in the photocurable ink is generally at least 2 weight %, or typically at least 60 weight % and up to and including 90 weight %, based on the total photocurable ink solids. The weight ratio of organic phosphite to photoinitiator in the photocurable ink is at least 0.5:1 and up to and including 50:1, or typically of at least 1:1 and up to and including 10:1.

The aldehydes useful in the photocurable inks include any compounds having one or more aldehyde (—CHO) moieties. It would be readily apparent to one skilled in the art that the chosen aldehyde should not interfere with curing radiation, with radiation absorption by the photoinitiator, and the basic chemistry of the photoinitiator. Most of the aldehydes are alkyl and aryl aldehydes having one or more aldehyde moieties. For example, useful aldehydes include R″—CHO compounds in which R″ is an alkyl or aryl group that is unsubstituted or substituted with one or more groups that do not adversely affect the behavior of the aldehyde moieties. For example, aryl aldehydes can be substituted or unsubstituted benzaldehydes and naphthaldehydes including but not limited to, 4-methoxybenzaldehyde, 4-methylbenzaldehyde, terephthalaldehyde, 2,5-dimethoxy-1,4-benzenedicarboxaldehyde, and naphthalene-1,4-dicarboxaldehyde. Useful alkyl aldehydes include but are not limited to compounds with substituted or unsubstituted alkyl groups having 1 to 20 carbon atoms in the alkyl group. As used herein, “alkyl group” also include substituted or unsubstituted cycloalkyl groups having 5 to 10 carbon atoms in the ring. Examples of useful alkyl aldehydes include but are not limited to, acetaldehyde, propionaldehyde, butyraldehyde, 2-methylbutyraldehyde, cyclohexanecarboxaldehyde, and cyclopentanecarboxaldehyde.

It is also possible that the “aldehyde” is an oligomeric or polymeric compound having recurring units wherein each unit comprises an aldehyde moiety and is represented for example by —(CH₂CH(CHO))—. Thus, in such embodiments, the R″ group noted above is an oligomeric or polymeric backbone and the oligomer or polymer has multiple aldehyde moieties along the backbone.

In one embodiment, the aldehyde has a single aldehyde moiety and a molecular weight less than 300. In other embodiments, the aldehyde has at one or two aldehyde moieties and a molecular weight less than 500.

The amount of aldehyde in the photocurable ink is chosen in relation to the amount of total organic phosphites. For example, the molar ratio of the organic phosphite to the aldehyde moieties in a composition of this invention is at least 1:1 and up to and including 4:1, or typically at least 1:1 and up to and including 3:1, although more or less phosphite can be used if desired. In some embodiments, the organic phosphite is present in a molar excess (greater than 1:1) compared to the aldehyde moieties in the photocurable ink.

An organic phosphite, for example as defined above in Structure (I), and an aldehyde present in the photocurable ink is believed to react to form an organic phosphite-aldehyde adduct, following the following reaction equation:

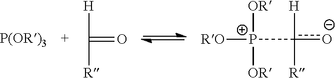

This complexation of phosphite with aldehyde happens rapidly at room temperature [for example, see F. Ramirez, Pure Appl. Chem. 1964, 9(2), 337-369] and results in reducing the unpleasant odor associated with many organic phosphites. This is especially true for some commonly available organic alkyl phosphites such as trimethyl phosphite and triethyl phosphite. It is believed that the compositions of this invention can include certain quantities of the organic phosphite-aldehyde adduct as well as unreacted organic phosphite or aldehyde. Unreacted organic phosphites are particularly present when they are included in molar excess relative to the aldehyde moieties in the photocurable ink. The organic phosphite-aldehyde adduct, in some cases, can react with another molecule of aldehyde to form tetraalkoxyphosphoranes. In some embodiments, R′ is a substituted or unsubstituted alkyl group and R″ is a substituted or unsubstituted phenyl group. This modified photocurable ink can also contain non-reacted organic phosphite especially if a molar excess of organic phosphite is present in the original photocurable ink. Thus, the modified photocurable ink can be prepared by mixing a suitable photoinitiator, an organic phosphite, and an aldehyde at room temperature in a suitable organic solvent. Examples of useful organic solvents include but are not limited to, ethyl methyl ketone, ethyl acetate, chloroform, methylene chloride, acetonitrile, toluene, xylenes, hexane, heptanes, petroleum ether, diethyl ether, and mixtures of two or more of these solvents. The modified photocurable ink also can be prepared by mixing a suitable photoinitiator, an organic phosphite, and an aldehyde directly with a photocurable compound, which could also serve as the solvent for the resulting photocurable ink.

In many embodiments, the photocurable inks further comprise a photosensitizer for the photoinitiator. Photosensitizers useful in present invention include any compounds capable of transferring energy from its own lowest excited state after it has absorbed radiation, to the photoinitiator. The driving force for this process depends upon the triplet energy of photosensitizer, (E^{T})ₛ, and the triplet energy of photoinitiator, (E^{T})_{P}. Thus, for the energy transfer from photosensitizer to photoinitiator to take place the triplet energy of photosensitizer (E^{T})ₛ should to be greater or equal to the triplet energy of photoinitiator, (E^{T})_{P}. Even in cases where the triplet energy of the photosensitizer is slightly lower than that of photoinitiator, energy transfer is feasible.

The amount of photosensitizer used in such embodiments of the photocurable inks of this invention depends largely on its optical density at the wavelength(s) of radiation used to initiate curing. Solubility of the photosensitizer in a photocurable ink can also be a factor. It is possible that the photosensitizer is a covalently bound part of a photocurable compound such as an acrylate. Either a photosensitizer bound in this manner or a non-bound photosensitizer with a low extinction coefficient can be utilized at relatively high levels to help facilitate the transfer of an electron to the photoinitiator from a triplet photosensitizer (³S). When covalently attached to a polymeric photocurable compound, the photosensitizer can be present in an amount of at least 0.01 and up to and including 10 weight % based on the total weight of the photoinitiator. An example of such a covalently bound photosensitizer is a benzophenone moiety (that absorbs actinic radiation) that is bound to a photocurable compound, or it can be attached to an inert polymeric binder. The amount of the photosensitizers is generally governed by their molar absorptivity or extinction coefficient. Photosensitizers that are not bound to photocurable compounds or polymers can be present in an amount of at least 1 and up to and including 10 weight %, based on the total weight of photoinitiator.

The triplet energies of the photosensitizers useful in present invention are known (for example see Handbook of Photochemistry, Eds. Steven L. Murov, Ian Carmichael, Gordon L. Hug, 1993, Marcel Dekker, Inc.). Energies for some photosensitizers or closely related analogs are also disclosed in other literature. Methods to experimentally measure triplet energies are also commonly known in the literature [for example see J. Amer. Chem. Soc. 102, 2152 (1980) and J. Phys. Chem, 78, 196 (1974)].

Some useful photosensitizers absorb visible light or near ultraviolet light, for example at a wavelength of at least 250 nm and up to and including 450 mu. The ketocoumarins disclosed in Tetrahedron 38, 1203 (1982) represent one class of such useful photosensitizers. The ketocoumarins described in U.K. Patent Publication 2,083,832 (Specht et al.) are also useful photosensitizers. The ketocoumarins exhibit very triplet state generation efficiencies. Other classes of useful photosensitizers include but are not limited to, benzophenones, xanthones, thioxanthones, arylketones and polycyclic aromatic hydrocarbons.

The weight ratio of organic phosphite to photoinitiator to photosensitizer in some photocurable inks is at least 0.1:1:0.1 and up to and including 50:1:1, or typically of at least 1:1:0.1 and up to and including 5:1:0.5.

Useful photocurable compounds may be unsaturated monomers and oligomers examples of which include ethylene, propylene, vinyl chloride, isobutylene, styrene, isoprene, acrylonitrile, acrylic acid, methacrylic acid, ethyl acrylate, ethyl methacrylate, methyl acrylate, methyl methacrylate, butyl acrylate, vinyl acrylate, allyl methacrylate, tripropylene glycol diacrylate and other diacrylates and dimethacrylates, various triacrylates and tri-methylacrylates, trimethylol propane ethoxylate acrylate, epoxy acrylates such as the reaction products of a bisphenol A epoxide with acrylic acid, polyether acrylates such as the reaction products of acrylic acid with an adipic acid/hexanediol-based polyether, urethane acrylates such as the reaction product of hydroxypropyl acrylate with diphenylmethane-4,4′-diisocyanate, and polybutadiene diacrylate oligomers.

In many embodiments, the photocurable compound is a mono- or multi-functional acrylate (also intended to include methacrylates) that is considered herein to be any material of any molecular weight that has at least one ethylenically unsaturated group. Such acrylates can be ethylenically unsaturated polymerizable monomers, oligomers, and crosslinkable polymers. The acrylates can have multiple acrylate groups (for example diacrylates and triacrylates). In other embodiments, the photocurable compounds are resins having a weight average molecular weight of at least 100,000.

Many of these embodiments of photocurable inks can also includes one or more photosensitizers, as described above, that absorb appropriate actinic radiation and are raised to an active state during photocuring.

In addition, the photocurable inks can include other materials as desired, such as colorant dispersing aids, extenders, amine synergists, and such other additives as are well known to those having ordinary skill in the art. Alternatively, these addenda can be added to the photocurable ink during photocuring.

In the photocurable inks, a photosensitizer for the photoinitiator can be present in an amount of at least 0.1 weight % and up to and including 10 weight %, or at least 0.5 weight % and up to and including 5 weight %, or more typically at least 1 weight % and up to and including 2 weight %, of the photocurable ink.

The photoinitiator concentrations in the photocurable inks can be specified in terms of weight % of photoinitiator in per gram of photocurable compound (or acrylate). Typical concentrations of photoinitiator are at least 0.1 weight % and up to and including 20 weight %, or typically at least 0.5 weight % and up to and including 10 weight %, or more typically at least 1 weight % and up and including 5 weight % of photocurable ink. The exact amount of photoinitiator that is used, as is commonly understood by one skilled in the art, depends largely on its molar absorptivity at the wavelength of excitation and the efficiency of radical generation.

In addition, the organic phosphite can be present in the photocurable ink in an amount of at least 0.5 weight % and up to and including 20 weight %, typically at least 1 weight % and up to and including 10 weight %, or more typically at least 2 weight % and up to and including 10 weight % of the photocurable ink. The use of larger amounts of organic phosphite is also possible.

A photocurable ink can be used in various imaging operations, which photocurable ink comprises a suitable colorant dissolved or dispersed a solvent such as an organic solvent, a photoinitiator (for example, the compounds and amounts described above), an organic phosphite (such as those defined by Structure (I) above in the amounts described above), and a photocurable compound (such as an acrylate as described above). For example, the amount of organic phosphite is present in the photocurable ink in an amount of at least 1 and up to and including 20 weight %.

The colorant for use in the photocurable inks can be selected from any suitable soluble dye or pigment dispersion, or a combination thereof. The colorant can be anionic or cationic. The colorant can be present with or without a dispersing agent, which compounds are known in the art.

When dyes are used in the photocurable inks that can be used as ink jetable inks, any suitable commercially available dye can be used to impart the desired color characteristics to the compositions. Either anionic or cationic dyes are useful, but most useful dyes are anionic. Anionic dyes are those in which a negative charge is localized on one atom or spread over the entire molecule. Cationic dyes are those in which a positive charge is localized on one atom or spread over the entire molecule.

Specific examples of useful anionic dyes include Bernacid Red 2BMN, Pontamine Brilliant Bond Blue A, Pontamine, Food Black 2, Carodirect Turquoise FBL Supra Conc. (Direct Blue 199, Carolina Color and Chemical), Special Fast Turquoise 8GL Liquid (Direct Blue 86, Mobay Chemical), Intrabond Liquid Turquoise GLL (Direct Blue 86, Crompton and Knowles), Cibracron Brilliant Red 38-A (Reactive Red 4, Aldrich Chemical), Drimarene Brilliant Red X-2B (Reactive Red 56, Pylam, Inc.), Levafix Brilliant Red E-4B (Mobay Chemical), Levafix Brilliant Red E-6BA (Mobay Chemical), Pylam Certified D&C Red #28 (Acid Red 92, Pylam), Direct Brill Pink B Ground Crude (Crompton & Knowles), Cartasol Yellow GTF Presscake (Sandoz, Inc.), Tartrazine Extra Conc. (FD&C Yellow #5, Acid Yellow 23, Sandoz, Inc.), Carodirect Yellow RL (Direct Yellow 86, Carolina Color and Chemical), Cartasol Yellow GTF Liquid Special 110 (Sandoz, Inc.), D&C Yellow #10 (Acid Yellow 3, Tricon), Yellow Shade 16948 (Tricon), Basacid Black X34 (BASF), Carta Black 2GT (Sandoz, Inc.), Neozapon Red 492 (BASF), Orasol Red G (Ciba-Geigy), Direct Brilliant Pink B (Crompton-Knolls), Aizen Spilon Red C-BH (Hodagaya Chemical Company), Kayanol Red 3BL (Nippon Kayaku Company), Levanol Brilliant Red 3BW (Mobay Chemical Company), Levaderm Lemon Yellow (Mobay Chemical Company), Aizen Spilon Yellow C-GNH (Hodagaya Chemical Company), Spirit Fast Yellow 3G, Sirius Supra Yellow GD 167, Cartasol Brilliant Yellow 4GF (Sandoz), Pergasol Yellow CGP (Ciba-Geigy), Orasol Black RL (Ciba-Geigy), Orasol Black RLP (Ciba-Geigy), Savinyl Black RLS (Sandoz), Dermacarbon 2GT (Sandoz), Pyrazol Black BG (ICI Americas), Morfast Black Conc A (Morton-Thiokol), Diazol Black RN Quad (ICI Americas), Orasol Blue GN (Ciba-Geigy), Savinyl Blue GLS (Sandoz, Inc.), Luxol Blue MBSN (Morton-Thiokol), Sevron Blue 5GMF (ICI Americas), and Basacid Blue 750 (BASF); Levafix Brilliant Yellow E-GA, Levafix Yellow E2RA, Levafix Black EB, Levafix Black E-2G, Levafix Black P-36A, Levafix Black PN-L, Levafix Brilliant Red E6BA, and Levafix Brilliant Blue EFFA, all available from Bayer; Procion Turquoise PA, Procion Turquoise HA, Procion Turquoise Ho5G, Procion Turquoise H-7G, Procion Red MX-5B, Procion Red H8B (Reactive Red 31), Procion Red MX 8B GNS, Procion Red G, Procion Yellow MX-8G, Procion Black H-EXL, Procion Black P-N, Procion Blue MX-R, Procion Blue MX-4GD, Procion Blue MX-G, and Procion Blue MX-2GN, all available from ICI Americas; Cibacron Red F-B, Cibacron Black BG, Lanasol Black B, Lanasol Red 5B, Lanasol Red B, and Lanasol Yellow 46, all available from Ciba-Geigy; Baslien Black P-BR, Baslien Yellow EG, Baslien Brilliant Yellow P-3GN, Baslien Yellow M-6GD, Baslien Brilliant Red P-3B, Baslien Scarlet E-2G, Baslien Red E-B, Baslien Red E-7B, Baslien Red M-5B, Baslien Blue E-R, Baslien Brilliant Blue P-3R, Baslien Black P-BR, Baslien Turquoise Blue P-GR, Baslien Turquoise M-2G, Baslien Turquoise E-G, and Baslien Green E-6B, all available from BASF; Sumifix Turquoise Blue G, Sumifix Turquoise Blue H-GF, Sumifix Black B, Sumifix Black H-BG, Sumifix Yellow 2GC, Sumifix Supra Scarlet 2GF, and Sumifix Brilliant Red 5BF, all available from Sumitomo Chemical Company; Intracron Yellow C-8G, Intracron Red C-8B, Intracron Turquoise Blue GE, Intracron Turquoise HA, and intracron Black RL, all available from Crompton and Knowles, Dyes and Chemicals Division. Mixtures of these colorants also can be used. Dyes that are invisible to the naked eye but detectable when exposed to radiation outside the visible wavelength range (such as ultraviolet or infrared radiation), such as dansyl-lysine, N-(2-amino-ethyl)-4-amino-3,6-disulfo-1,8-dinaphthalimide dipotassium salt, N-(2-aminopentyl)-4-amino-3,6-disulf-o-1,8-dinaphthalimide dipotassium salt, Cascade Blue ethylenediamine trisodium salt (available from Molecular Proes, Inc.), Cascade Blue cadaverine trisodium salt (available from Molecular Proes, Inc.), bisdiazinyl derivatives of 4,4′-diaminostilbene-2,2′-disulfonic acid, amide derivatives of 4,4′-diamino-stilbene-2,2′-disulfonic acid, phenylurea derivatives of 4,4′-disubstituted stilbene-2,2′-disulfonic acid, mono- or di-naphthyltriazole derivatives of 4,4′-disubstituted stilbene disulfonic acid, derivatives of benzothiazole, derivatives of benzoxazole, derivatives of benzimidazole, derivatives of coumarin, derivatives of pyrazolines containing sulfonic acid groups, 4,4′-bis(triazin-2-ylamino)stilbene-2,2′-disulfonic acids, 2-(stilben-4-yl)naphthotriazoles, 2-(4-phenylstilben-4-yl)benzoxazoles, 4,4-bis(triazo-2-yl)stilbene-2,2′-disulfonic acids, 1,4-bis(styryl)-biphenyls, 1,3-diphenyl-2-pyrazolines, bis(benzazol-2-yl) derivatives, 3-phenyl-7-(triazin-2-yl)coumarins, carbostyrils, naphthalimides, 3,7-diamino-dibenzothiophen-2,8-disulfonic acid-5,5-dioxide, other commercially available materials, such as C.I. Fluorescent Brightener No. 28 (C.I. 40622), and the fluorescent series Leucophor B-302, BMB (C.I. 290), BCR, and BS (available from Leucophor) are also useful.

Examples of additional suitable dyes include, but are not limited to, anthraquinones, monoazo dyes, diazo dyes, phthalocyanines, aza[18]annulenes, formazan copper complexes, Bernacid Red (Berncolors, Poughkeepsie, N.Y.), Pontamine Brilliant Bond Blue, Berncolor A. Y. 34, Telon Fast Yellow 4GL-175, Basacid Black SE 0228 (BASF), the Pro-Jet series of dyes available from ICI, including Pro-Jet Yellow I (Direct Yellow 86), Pro-Jet Magenta I (Acid Red 249), Pro-Jet Cyan I (Direct Blue 199), Pro-Jet Black I (Direct Black 168), and Pro-Jet Yellow 1-G (Direct Yellow 132), Pro-Jet Fast Yellow, Cyan and Magenta (Zeneca Inc.), Aminyl Brilliant Red F-B (Sumitomo Chemical Co.), the Duasyn line of “salt-free” dyes available from Hoechst, such as Duasyn Direct Black HEF-SF (Direct Black 168), Duasyn Black RL-SF (Reactive Black 31), Duasyn Direct Yellow 6G-SF VP216 (Direct Yellow 157), Duasyn Brilliant Yellow GL-SF VP220 (Reactive Yellow 37), Duasyn Acid Yellow XX-SF VP413 (Acid Yellow 23), Duasyn Brilliant Red F3B-SF VP218 (Reactive Red 180), Duasyn Rhodamine B-SF VP353 (Acid Red 52), Duasyn Direct Turquoise Blue FRL-SF VP368 (Direct Blue 199), and Duasyn Acid Blue AE-SF VP344 (Acid Blue 9), and mixtures thereof.

Examples of cationic dyes include the following from Crompton & Knowles Corp: Sevron Yellow L200 200%, Sevron Brilliant Red 4G 200%, Sevron Brilliant Red B 200%, Sevron Blue 2G, Sevron Black B1, Basic Black PSr, and Basic Black RX. Other cationic dyes can also be used in photocurable inks.

In addition, the colorant for the photocurable inks can be a pigment, or a mixture of one or more dyes, or one or more dyes and one or more pigments. The pigment can be black, cyan, magenta, yellow, red, blue, green, or brown pigments or mixtures thereof. Examples of suitable black pigments include various carbon blacks such as channel black, furnace black, and lamp black, such as Levanyl Black A-SF (Miles, Bayer) CAB-O-JET 200™ and CAB-O-JET 300™ (Cabot) and Sunsperse Carbon Black LHD 9303 (Sun Chemicals). Colored pigments include red, green, blue, brown, magenta, cyan, and yellow particles, as well as mixtures thereof. Illustrative examples of magenta pigments include 2,9-dimethyl-substituted quinacridone and anthraquinone, identified in the Color Index as CI 60710, CI Dispersed Red 15, and CI Solvent Red 19. Illustrative examples of suitable cyan pigments include copper tetra-4-(octadecyl sulfonamido)phthalocyanine, X-copper phthalocyanine pigment, listed in the Color Index as CI 74160, CI Pigment Blue, and Anthradanthrene Blue, identified in the Color Index as CI 69810, and Special Blue X-2137. Illustrative examples of yellow pigments include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy acetoacetanilide, and Permanent Yellow FGL. Additional examples of pigments include Normandy Magenta RD-2400 (Paul Uhlich), Sunsperse Quindo Magenta QHD 6040 (Sun Chemicals), Paliogen Violet 5100 (BASF), Paliogen Violet 5890 (BASF), Permanent Violet VT2645 (Paul Uhlich), Heliogen Green L8730 (BASF), Argyle Green XP-111-S (Paul Uhlich), Brilliant Green Toner GR 0991 (Paul Uhlich), Heliogen Blue L6900 and L7020 (BASF), Heliogen Blue D6840 and D7080 (BASF), Sudan Blue OS (BASF), PV Fast Blue B2GO1 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Tolidine Red (Aldrich), Scarlet for Thermoplast NSD PS PA (Ugine Kuhlmann of Canada), E. D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), and Lithol Fast Scarlet L4300 (BASF).

Additional suitable commercially available pigment dispersions include: Hostafine™ pigments available from Celanese Corporation, including Hostafine Black T, Hostafine Black TS, Hostafine Yellow HR, Hostafine Yellow GR, Hostafine Red FRLL, Hostafine™ Rubine F6B, and Hostafine™ Blue B2G; pigment dispersions available from Bayer AG including Levanyl™ Yellow 5GXZ-SF; pigment dispersions available from Degussa Company including Derussol™ carbon black pigment dispersions comprising Derussol™ Z350S, Derussol™ VU 25/L, Derussol™ 345, and Derussol(D 3450S; pigment dispersions available from BASF Corporation, including Disperse Black 006607, Luconyl™ Yellow 1250, Basoflex Pink 4810, and Luconyl™ Blue 7050; and pigment dispersions available from Sun Chemical Corporation including, Sunsperse™ Red RHD 9365 and Sunsperse™ Magenta W83012.

It is generally desired that pigment colorants used in the photocurable inks have a particle size as small as possible to enable a stable dispersion of the particles in the liquid vehicle and to prevent clogging of the ink channels or nozzle when the ink is used in an ink jet printer. For example, the particle average diameters are generally at least 0.001 and up to and including 0.3 μm, although particle sizes outside this range can be used. Generally, at least 70% of the pigment particles should have an average diameter of less than about 0.1 μm for carbon blacks and 0.3 μm for color pigments.

When dyes are used as colorants, the dyes are present in the photocurable ink in any effective amount and combinations needed to provide a desired color. For example, one or more dyes are present in an amount of at least 1 and up to and including 15% by weight of the photocurable ink, and typically at least 2 and up to and including 8% by weight (wherein the amount refers to an amount of dye molecules present in the photocurable ink), although the amounts can be outside these ranges. A mixture of dyes in the proportions desired to obtain a specific shade can also be used.

Similarly, when pigments are used, the pigments can be present in the photocurable inks in any effective amount. Generally, one or more pigments are present in an amount of at least 1% and up to and including 10% by weight of the photocurable ink composition solids, and typically at least 2% and up to and including 8% by weight, although the amounts can be outside of these ranges. When both dyes and pigments are incorporated into the photocurable inks, the weight percentage of the combined colorants can be adjusted accordingly.

Pigments can be dispersed in the photocurable inks using one or more dispersants that can be anionic, cationic, or nonionic. Ionic dispersants have both ionic (capable of ionization in water) and hydrophobic (affinity for pigments) moieties. Suitable nonionic dispersants include, but are not limited to, ethoxylated monoalkyl or dialkyl phenols including Igepal™ CA and CO series materials (Rhone-Poulenc Co.), Triton™ series materials (Union Carbide Company), and Fluorad FC430 (ex 3M Corp.) materials. Such surfactants (when present) can be present in an amount of at least 0.1% and up to and including 10% by weight of the total photocurable ink.

The weight ratio of pigment to pigment dispersant(s) in the photocurable ink can be at least 1:0.01 and up to and including 1:3, or typically at least 1:0.1 and up to and including 1:1. The photocurable ink should contain enough dispersant to stabilize the pigment particle dispersion, but not so much as to adversely affect properties of the photocurable ink viscosity, stability, and optical density.

In some embodiments, the photocurable inks are substantially free or totally free of organic solvents, meaning that they less than 10%, or less than 5% of organic solvent(s) based on the total weight of the photocurable ink.

The photocurable inks can also contain certain photocurable resins present that have a small enough particle size so as not to result in clogging of ink jet heads or nozzles. A smaller particle size is desired since this will reduce the chance of forming aggregates that could potentially plug the ink jet printing head or nozzle. Typical photocurable resins used in the photocurable inks have a mean particle size at least 30 and up to and including 80 nm. While photocurable resin with a mean particle size of about 70 to about 80 nanometers, or typically a mean particle size of at least 30 and up to and including 50 nm particularly if an ink cartridge is to be refilled and reused. Examples of suitable photocurable resins include, but are not limited to, urethane resins, acrylic resins, polyester resins, epoxy acrylate resins, and mixtures thereof, wherein the photocurable resins contain a sufficient level of unsaturation for example carbon-carbon double bonds groups to enable the resin to photopolymerize at a rate practical for the desired printing speed. The resins can be from any backbone, but an aliphatic backbone is currently preferred for uses where the final printed article must have the optimum durability. Typically, the unsaturation is obtained from acrylate or methacrylate functionality such as acrylate based monomers including polyfunctional alkoxylated acrylate monomers such as di- or tri-acrylates. However, alkoxylated or polyalkoxylated acrylic monomers of higher functionality can also be used alone or together with one or more di- or trifunctional materials. It is desired that the total amount of the polyfunctional material (alkoxylated+polyalkoxylated) is in the range at least 80% and up to and including 95% by weight of the photocurable ink. The number of alkoxy groups can be from 1 to 20 per molecule of the monomer. The alkyleneoxy group can be a C₂-C₄ alkyleneoxy, such as ethoxy (EO) or propoxy (PO) groups. Suitable polyfunctional alkoxylated or polyalkoxylated acrylates can be selected from alkoxylated such as ethoxylated or propoxylated, variants of the following: neopentyl glycol diacrylates, butanediol diacrylates, trimethylpropane tri-acrylates and glyceryl triacrylate.

Optionally, photocurable inks can also contain some monofunctional alkoxylated or polyalkoxylated acrylated monomer material, for example up to 10% by weight of the total photocurable ink for example selected from one or more of alkoxylated (ethoxylated or propoxylated) variants of the following: tetrahydrofurfuryl acrylates, cyclohexyl acrylates, alkyl acrylates, nonyl-phenol acrylate and polyethylene or polypropylene glycol acrylates. The photocurable inks can also comprise minor amounts of non-alkoxylated radiation curable monomer material, either monofunctional or polyfunctional, such as up to no more than 5% by weight of the photocurable ink, for example selected from one or more of octyl acrylate, decyl acrylate, N-vinylpyrolidone, ethyl diglycol acrylate, isobornyl acrylate, ethyl-hexyl acrylate, lauryl acrylate, butanediol monoacrylate, β-carboxyethyl acrylate, isobutyl acrylate, polypropylene glycol monomethacrylate, 2-hydroxyethyl methacrylate, difunctional (meth)acrylic acid esters, for example hexanediol di-(meth)acrylate, tetraethylene glycol diacrylate, tripropylene glycol diacrylate, butanediol diacrylate, polyethylene glycol diacrylates and triethylene glycol dimethacrylate.

Photocurable inks optionally comprise one or more minor ingredients, for example, surfactants, leveling additives, stabilizers, wetting agents, and pigment stabilizers that are known in the art. Pigment stabilizers can be for example polyester, polyurethane, or polyacrylate types, especially in the form of high molecular weight block co-polymers, and would typically be incorporated in an amount of at least 2.5% and up to and including 100% by weight of the pigment. Suitable examples are Disperbyk 161 or 162 (ex BYK Chemie) or Solsperse ex Zeneca.

The amounts of the polymerizable monomer(s), photoinitiator, organic phosphite, colorant (and optional aldehyde) in the photocurable inks can vary according to the particular equipment and application.

The photocurable inks can also include one or more photosensitizers as described above, for example wherein the weight ratio of the photoinitiator to the photosensitizer is at least 1:1 and up to and including 100:1. Other details of the photocurable inks would be readily apparent to a skilled worker using the teaching provided in this disclosure.

These photocurable inks can be used in various methods. For example, a method of applying an ink comprises:

providing the photocurable ink described herein,

curing the photocurable ink by irradiating it with curing radiation, and

before or during curing, applying the photocurable ink to a substrate.

In some embodiments, the photocurable ink is only partially cured with the curing radiation before application to the substrate. This procedure can be used to modify the viscosity of the photocurable ink. In other embodiments, the photocurable ink is applied to the substrate before any curing. It is particularly advantageous that these methods can be carried out in the presence of oxygen.

Thus, in some embodiments, the photocurable ink comprises: a colorant dispersed within a solvent,

an organic phosphite in the photocurable composition that is represented by the following Structure (I) or (II):

(R′O)₃P (I)

wherein the multiple R′ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or two R′ groups can form a cyclic aliphatic ring or fused ring system,

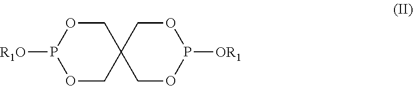

wherein the two R₁ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or the two R₁ groups can form a substituted or unsubstituted cyclic aliphatic ring or fused ring system, and

x is a number at least 2 and up to and including 20, and y is at least 1 and up to and including 20,

a photoinitiator that is one or more of a benzoin, aryl ketone, α-amino ketone, mono- or bis(acyl)phosphine oxide, benzoin alkyl ether, benzil ketal, phenylglyoxalic ester or derivatives thereof, oxime ester, per-ester, ketosulfone, phenylglyoxylate, borate, and metallocene,

a photosensitizer for the photoinitiator that is selected from the group consisting of ketocoumarins, benzophenones, xanthones, thioxanthones, arylketones, and polycyclic aromatic hydrocarbons, and

a photocurable compound that is an acrylate.

The photocurable inks can also include one or more photosensitizers as described above, for example wherein the weight amount of the photoinitiator to the photosensitizer is at least 1:1 and up to and including 100:1. Other details of the photocurable inks would be readily apparent to a skilled worker using the teaching provided in this disclosure.

These photocurable inks can be used in various methods. For example, a method of applying an ink comprises:

providing the photocurable ink described herein (either with or without the presence of an aldehyde),

curing the photocurable ink by irradiating it with curing radiation, and

before or during curing, applying the photocurable ink to a substrate.

In some embodiments, the photocurable ink is only partially cured with the curing radiation before application to the substrate. This procedure can be used to modify the viscosity of the photocurable ink. In other embodiments, the photocurable ink is applied to the substrate before any curing. It is particularly advantageous that these methods can be carried out in the presence of oxygen.

### Methods of Photocuring and Uses Thereof

The present invention is also directed to a method of generating free radicals to affect photocuring, especially in oxygen-containing environments. The method of generating free radicals involves generating a free radical by exposing the described photoinitiator compositions to suitable actinic radiation. The exposure of the photoinitiator compositions to a radiation source triggers a photochemical process. As stated above, the term “quantum yield” is used herein to indicate the efficiency of a photochemical process.

The photoinitiator composition absorbs photons of specific wavelength(s) and transfers the absorbed energy to one or more excitable portions of the composition. The excitable portion of the compositions absorbs enough energy to cause a bond breakage that generates one or more free radicals. The efficiency with which radicals are generated with the photoinitiators depends on quantum yield of the given photoinitiator. Thus, the photoinitiators can be employed in any situation where radicals are required, such as described above for photocuring or photopolymerization.

A photocurable ink (as described above) is prepared or provided and irradiated, for example, in the presence of oxygen, to cause photocuring or polymerization of various photocurable compounds within the ink and used for providing any image.

The photocurable ink can be used to polymerize or cure a photocurable compound by exposure to suitable radiation for a time and energy sufficient for efficacious photocuring. The photocurable compound can be mixed with the photoinitiator compositions using any suitable mixing means known in the art, following which the mixture is irradiated with an amount of radiation. The amount of radiation sufficient to polymerize the compound is readily determinable by one of ordinary skill in the art, and depends upon the identity and amount of photoinitiator composition, the identity and amount of the photocurable compound, the intensity and wavelength of the radiation, and the duration of exposure to the radiation. Some photocurable inks can be partially cured, treated in some manner, and then subjected to further curing.

The photoinitiating inks can be prepared by simply mixing, under “safe light” conditions, the photoinitiating composition, or individually, the photoinitiator, optionally a photosensitizer for the photoinitiator, and an organic phosphite compound, with a suitable photocurable acrylate or other photocurable compound, and a colorant or colorant dispersion. This mixing can occur in suitable inert or non-reactive solvents. Examples of suitable solvents include but are not limited to, acetone, methylene chloride, and any other solvent that does not react appreciably with the phosphite, photoinitiator, photocurable compound, or photosensitizer.

A liquid organic material to be polymerized or photocured (such as an acrylate) can be used as the solvent for mixing, or it can be used in combination with another liquid. An inert or nonreactive solvent can be used also to aid in obtaining a solution of the materials and to provide suitable viscosity to the photocurable inks (described above), or other materials or operations. However, solvent-free photocurable inks also can be prepared by simply dissolving the photoinitiator, the organic phosphite, or photosensitizer in the organic photocurable material with or without mild heating.

The photocurable ink can be disposed on the substrate uniformly or in a pattern. For example, the photocurable ink can be disposed on, or alternatively applied to, the substrate in an imagewise pattern using an imagewise patterning. Printed circuit boards can be prepared from precursor articles in which a photocured image or pattern is applied using the photocurable ink, particularly in the presence of oxygen.

In some methods, the photocurable ink is partially cured during the irradiating step to provide a partially cured composition. For example, the photocurable ink can be jetted out of a nozzle before partial curing from the irradiating step to modify the viscosity of the photocurable ink. This process can also comprise a step of further curing the partially cured photocurable ink.

The irradiating step is carried out using curing radiation having a wavelength of at least 100 nm and up to and including 1250 nm, and particularly at a wavelength of at least 100 nm and up to and including 1,000 rim. The photocuring radiation may be ultraviolet radiation, including near ultraviolet and far or vacuum ultraviolet radiation, visible radiation, and near infrared radiation. Desirably, the radiation will have a wavelength of at least 100 nm and up to and including 900 nm, or typically at least 100 nm and up to and including 700 nm. Useful ultraviolet radiation has a wavelength of from at least 100 nm and up to and including 400 nm. The radiation desirably will be incoherent, pulsed ultraviolet radiation from a dielectric barrier discharge excimer lamp or radiation from a mercury lamp. Other sources of radiation can be used. The photocurable ink is dissolved or dispersed in a solvent before the irradiating step. Alternatively, the photocurable ink is mixed as a solution with at least one photocurable compound acting as the solvent. In either of these embodiments, the photocurable compound can be a photocurable acrylate. Thus, the method can further comprise applying the photocurable ink to a substrate before the irradiating step.

In these methods, the photocurable ink comprises the photoinitiator (described above) in an amount of at least 6×10⁻⁷ and up to and including 6×10⁻² moles per gram of one or more photocurable compounds (described above, such as acrylates). Moreover, the photocurable ink can further include a photosensitizer (described above) that is present in an amount of at least 5×10⁻⁷ and up to and including 1×10⁻⁴ moles per gram of the one or more photocurable compounds. The photocurable ink can comprise the organic phosphite (described above) in an amount described above. The one or more photocurable compounds can include a photocurable monomeric, oligomeric, or polymeric acrylate. In some embodiments, the one or more photocurable compounds comprise a photocurable acrylate that comprises a photosensitizer for the photoinitiator.

The photoinitiator composition can be used in a method of imaging comprising:

A) providing a photocurable ink comprising at least one photoinitiator (described above), at least one organic phosphite (described above), at least one aldehyde (described above), and at least one photocurable compound (described above, such as an acrylate) to form a photocurable ink, and

B) imagewise irradiating the photocurable ink to affect a cured image.

The photocurable ink can be applied to a substrate prior to the imagewise irradiating step. Moreover, the imagewise irradiating step can be carried out by irradiating the photocurable ink through a mask image.

The photocurable ink can be applied to a substrate (described above) during the imagewise irradiating step. For example, the photocurable ink can be applied to a metal substrate for use in providing a printed circuit board or photoresist. If desired, the photocurable ink further comprises a photosensitizer (described above) for the photoinitiator. Moreover, imagewise irradiating the photocurable ink can be carried out in a pattern and the non-cured portions of the photocurable ink can be removed by development. Useful developers would be readily apparent to a skilled worker and dependent upon the photocurable compound that is used. It is particularly advantageous to carry out imagewise irradiating in the presence of oxygen.

Evaluation of useful photoinitiator compositions as initiating systems for photopolymerization or photocuring can be carried out using an acrylate-based coating formulation (see Examples below). Irradiation to initiate photocuring can be carried out using a filtered mercury lamp output with or without band-pass filters. This is just one source of useful radiation. The efficiency of photopolymerization can be determined by the amount of photocured polymer retained after solvent development, which leaves behind only the areas that had sufficient exposure to cause crosslinking of the photocurable acrylates. Thus, a more efficient photoinitiator composition can create more crosslinked polymer than a less efficient photoinitiator composition.

The present invention provides at least the following embodiments and combinations thereof, but other combinations of features are considered to be within the present invention as a skilled artisan would appreciate from the teaching of this disclosure:

1. A photocurable ink comprising a colorant dissolved or dispersed within a solvent, a photoinitiator, an organic phosphite, an aldehyde, and a photocurable compound, wherein the organic phosphite is present in a molar excess relative to the aldehyde moieties in the photocurable ink.

2. The photocurable ink of embodiment 1 wherein the organic phosphite is present in a molar amount relative to the total aldehyde moieties of at least 1:1 and up to and including 4:1.

3. The photocurable ink of embodiment 1 or 2 comprising a pigment dispersed within a solvent.

4. The photocurable ink of any of embodiments 1 to 3 comprising a black, cyan, magenta, or yellow colorant.

5. The photocurable ink of any of embodiments 1 to 4 wherein the colorant is present in an amount of at least 1 and up to and including 10 weight %.

6. The photocurable ink of any of embodiments 1 to 5 wherein the organic phosphite is represented by the following Structure (I) or (II):

(R′O)₃P (I)

wherein the multiple R′ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or two R′ groups can form a cyclic aliphatic ring or fused ring system,

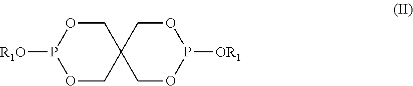

wherein the two R₁ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or the two R₁ groups can form a substituted or unsubstituted cyclic aliphatic ring or fused ring system, and

x is a number at least 2 and up to and including 20, and y is at least 1 and up to and including 20.

7. The photocurable ink of any of embodiments 1 to 6 comprising one or more of trimethyl phosphite, triethyl phosphite, tripropyl phosphite, tributyl phosphite, triisobutyl phosphite, triamyl phosphite, trihexyl phosphite, trinonyl phosphite, tri-(ethylene glycol)phosphite, tri-(propylene glycol)phosphite, tri(isopropylene glycol)phosphite, tri-(butylene glycol)phosphite, tri-(isobutylene glycol)phosphite, tri-(pentylene glycol)phosphite, tri-(hexylene glycol)phosphite, tri-(nonylene glycol)phosphite, tri-(diethylene glycol)phosphite, tri-(triethylene glycol)phosphite, tri-(polyethylene glycol)phosphite, tri-(polypropylene glycol)phosphite, and tri-(polybutylene glycol)phosphite.

8. The photocurable ink of any of embodiments 1 to 7 wherein the organic phosphite is present in an amount of at least 0.5 weight % and up to and including 20 weight %. 9. The photocurable ink of any of embodiments 1 to 8 wherein the photoinitiator is one or more of a benzoin, aryl ketone, α-amino ketone, mono-or bis(acyl)phosphine oxide, benzoin alkyl ether, benzil ketal, phenylglyoxalic ester or derivatives thereof, oxime ester, per-ester, ketosulfone, phenylglyoxylate, borate, and metallocene.

10. The photocurable ink of any of embodiments 1 to 9 wherein the photoinitiator is present in an amount of a molar ratio to the organic phosphite of at least 0.5:1 and up to and including 50:1.

11. The photocurable ink of any of embodiments 1 to 10 further comprising a photosensitizer for the photoinitiator that is selected from the group consisting of ketocoumarins, benzophenones, xanthones, thioxanthones, arylketones, and polycyclic aromatic hydrocarbons.

12. The photocurable ink of embodiment 11 wherein the molar ratio of the photoinitiator to the photosensitizer is at least 1:1 and up to and including 100:1.

13. The photocurable ink of any of embodiments 1 to 12 wherein the total amount of photoinitiators is generally at least 2 weight % and up to and including 80 weight %, based on the total photocurable ink weight, and the molar ratio of organic phosphite to photoinitiator is at least 0.5:1 and up to and including 50:1.

14. The photocurable ink of any of embodiments 1 to 13 wherein the photocurable compound is an acrylate.

15. The photocurable ink of any of embodiments 1 to 14 wherein the aldehyde is an alkyl or aryl aldehyde having one or more aldehyde moieties and a molecular weight of less than 500.

16. The photocurable ink of any of embodiments 1 to 15 further comprising a colorant dispersing aid.

17. A method of applying an ink comprising:

providing the photocurable ink of any of embodiments 1 to 16,

curing the photocurable ink by irradiating it with curing radiation, and

before or during curing, applying the photocurable ink to a substrate.

18. The method of embodiment 17 wherein the photocurable ink is only partially cured with the curing radiation before application to the substrate.

19. The method of embodiment 17 or 18 wherein the photocurable ink is applied to the substrate before any curing.

20. The method of any of embodiments 17 to 19 that is carried out in the presence of oxygen.

The present invention is further described by the examples which follow. Such examples, however, are not to be construed as limiting in any way either the spirit or the scope of the present invention. In the examples, all parts are by weight, unless stated otherwise.

The unexpected curing speed produced by the photocurable inks of the present invention is best understood by comparing their performance, when used with an organic phosphite and aldehyde, to the performance or photocurable inks without both an organic phosphite and aldehyde.

In all of the results shown below, the term “efficiency gain” refers to the increased “speed” of curing that is represented by the ratio of curing energy dose of the comparative composition to the inventive composition. In addition, the term “curing degree” can be evaluated by the extent of tackiness of the “cured” composition.

### COMPARATIVE INVENTION 1

### Black Photocurable Ink

Black Pearl 880 carbon black pigment (Degussa, 4 weight %, 0.4 g), Solsperse® 3900 dispersant (Lubrizol, 2 weight %, 0.2 g) and propoxylated neopentyl glycol diacrylate SR9003 (Sartomer, 34 weight % 3.4 g) were ball milled (2 mm diameter ceramic beads). After ball milling the dispersion, additional SR9003 (Sartomer, 45 weight %, 4.5 g) and polyester acrylate CN2283 (Sartomer, 5 weight %, 0.5 g) were added to the carbon black dispersion. The particle size of the carbon black pigment was about 300 nm. A mixture of photoinitiators, Genocure BDMM (Rahn USA Corp., 4 weight %, 0.4 g), Genocure EHA (Rahn USA Corp., 2.5 weight %, 0.25 g), Genocure ITX (Rahn USA Corp., 1 weight %, 0.1 g), and Genocure PBZ (Rahn USA Corp., 2.5 weight %, 0.25 g), was added into the pigment dispersion and stirred overnight in dark. A test patch (about 1 μm thick) was coated onto a glass plate and exposed to curing radiation (light) in air. The cure efficiency of the ink patch was evaluated based on its tackiness after light exposure. The results are summarized in TABLE IV below.

### INVENTION EXAMPLE 1

### Black Photocurable Ink

Black Pearl 880 carbon black pigment (Degussa, 4 weight %, 0.4 g), Solsperse® 3900 dispersant (Lubrizol, 2 weight %, 0.2 g) and propoxylated neopentyl glycol diacrylate SR9003 (Sartomer, 34 weight % 3.4 g) were ball milled (using 2 mm diameter ceramic beads). After ball milling, additional SR9003 (Sartomer, 45 weight %, 4.5 g) and polyester acrylate CN2283 (Sartomer, 5 weight %, 0.5 g) were added to the pigment dispersion. The average particle size of the carbon black pigment was about 300 nm. A mixture of photoinitiators, Genocure BDMM (Rahn USA Corp., 4 weight %, 0.4 g), Genocure EHA (Rahn USA Corp., 2.5 weight %, 0.25 g), Genocure ITX (Rahn USA Corp., 1 weight %, 0.1 g), and Genocure PBZ (Rahn USA Corp., 2.5 weight %, 0.25 g), was added to the carbon black dispersion and stirred overnight in the dark. Triethylphosphite (5 weight %) and 4-methoxybenzaldehyde (4 weight %) were then added to the carbon black dispersion and mixed thoroughly. A test patch (about 1 μm thick) was coated on a glass plate to provide a useful article and then exposed to curing radiation in the presence of oxygen (in air). The cure efficiency of the ink patch was evaluated based on tackiness of the ink patch after irradiation. The results are summarized in TABLE I below.

TABLE I

| | Dose | Efficiency | |
|---|---|---|---|
| | (mJ/cm²) | Gain | Curing Degree |
| Comparative Invention 1 (no | 5500 | | Very poor |
| phosphite or aldehyde) | | | curing, patch |
| | | | very tacky |
| Invention Example 1 | 200 | 28 times | Good—little or |
| (phosphite and aldehyde) | | | no tackiness |

The results provided in TABLE I clearly show considerable improvement in the photocuring of a black-pigmented photocurable ink in air when the photocurable ink contained an organic phosphite and aldehyde according to this invention.

### COMPARATIVE EXAMPLE 2

### Yellow Photocurable Ink

Yellow pigment PY-185 (BASF, 4 weight %, 0.4 g), Solsperse® 13240 dispersant (Lubrizol, 4 weight %, 0.4 g), and 2-ethylhexyl acrylate (Aldrich, 30.1 weight % 3.1 g) were ball milled (using 2 mm diameter ceramic beads). After ball milling, additional SR9003 (Sartomer, 46 weight %, 4.6 g) and polyester acrylate CN2283 (Sartomer, 5 weight %, 0.5 g) were added to the pigment dispersion. The average particle size of the yellow pigment was about 300 nm. A mixture of photoinitiators, Genocure BDMM (Rahn USA Corp., 4 weight %, 0.39 g), Genocure EHA (Rahn USA Corp., 2.5 weight %, 0.26 g), Genocure ITX (Rahn USA Corp., 1 weight %, 0.1 g), and Genocure PBZ (Rahn USA Corp., 2.5 weight %, 0.25 g), was added to the pigment dispersion that was then stirred overnight in the dark. A test patch (about 1 pm thick) was coated on a glass plate to provide an article and exposed to curing radiation in air. The cure efficiency of ink patch was evaluated based on the tackiness of the yellow ink patch after irradiation. The results are summarized in TABLE V below.

### INVENTION EXAMPLE 2

### Yellow Photocurable Ink

Yellow pigment PY-185 (BASF, 4 weight %, 0.4 g), Solsperse® 13240 dispersant (Lubrizol, 4 weight %, 0.4 g), and 2-ethylhexyl acrylate (Aldrich, 30.1 weight % 3.1 g) were ball milled (using 2 mm diameter ceramic beads). After ball milling, additional SR9003 (Sartomer, 46 weight %, 4.6 g) and polyester acrylate CN2283 (Sartomer, 5 weight %, 0.5 g) were added to the pigment dispersion. The average particle size of the yellow pigment was about 300 nm. A mixture of photoinitiators, Genocure BDMM (Rahn USA Corp., 4 weight %, 0.39 g), Genocure EHA (Rahn USA Corp., 2.5 weight %, 0.26 g), Genocure ITX (Rahn USA Corp., 1 weight %, 0.1 g), and Genocure PBZ (Rahn USA Corp., 2.5 weight %, 0.25 g), was added to the pigment dispersion that was then stirred overnight in the dark. Triethylphosphite (5 weight %) and 4-methoxybenzaldehyde (4 weight %) were added and mixed thoroughly. A test patch (about 1 μm thick) was coated onto a glass plate to provide a useful article and then exposed to curing radiation in air. The cure efficiency of the photocurable ink patch was evaluated based on tackiness of the ink patch after irradiation. The results are summarized in TABLE II below.

TABLE II

| | Dose | Efficiency | |
|---|---|---|---|
| | (mJ/cm²) | Gain | Curing Degree |
| Comparative Example 2 | 6500 | | Very poor |
| (no phosphite or aldehyde) | | | curing. Patch |
| | | | very tacky |
| Invention Example 2 | 190 | 34 times | Good—little or |
| (phosphite and aldehyde) | | | no tackiness |

The results provided in TABLE II clearly show considerable improvement using the photocurable ink of this invention when cured in the presence of oxygen compared with the comparative photocurable ink.

The invention has been described in detail with particular reference to certain preferred embodiments thereof, but it will be understood that variations and modifications can be effected within the spirit and scope of the invention.

1. A photocurable ink comprising a colorant dissolved or dispersed within a solvent, a photoinitiator, an organic phosphite, an aldehyde, and a photocurable compound, wherein the organic phosphite is present in a molar excess relative to the aldehyde moieties in the photocurable ink.

2. The photocurable ink of claim 1 wherein the organic phosphite is present in a molar amount relative to the total aldehyde moieties of at least 1:1 and up to and including 4:1.

3. The photocurable ink of claim 1 comprising a pigment dispersed within a solvent.

4. The photocurable ink of claim 1 comprising a black, cyan, magenta, or yellow colorant.

5. The photocurable ink of claim 1 wherein the colorant is present in an amount of at least 1% and up to and including 10% solids.

6. The photocurable ink of claim 1 wherein the organic phosphite is represented by the following Structure (I) or (II):
(R′O)₃P (I)
wherein the multiple R′ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or two R′ groups can form a cyclic aliphatic ring or fused ring system, 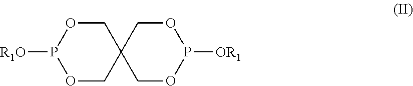
wherein the two R₁ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or the two R₁ groups can form a substituted or unsubstituted cyclic aliphatic ring or fused ring system, and
x is a number at least 2 and up to and including 20, and y is at least 1 and up to and including 20.

7. The photocurable ink of claim 1 comprising one or more of trimethyl phosphite, triethyl phosphite, tripropyl phosphite, tributyl phosphite, triisobutyl phosphite, triamyl phosphite, trihexyl phosphite, trinonyl phosphite, tri-(ethylene glycol)phosphite, tri-(propylene glycol)phosphite, tri(isopropylene glycol)phosphite, tri-(butylene glycol)phosphite, tri-(isobutylene glycol)phosphite, tri-(pentylene glycol)phosphite, tri-(hexylene glycol)phosphite, tri-(nonylene glycol)phosphite, tri-(diethylene glycol)phosphite, tri-(triethylene glycol)phosphite, tri-(polyethylene glycol)phosphite, tri-(polypropylene glycol)phosphite, and tri-(polybutylene glycol)phosphite.

8. The photocurable ink of claim 1 wherein the organic phosphite is present in an amount of at least 0.5 weight % and up to and including 20 weight %.

9. The photocurable ink of claim 1 wherein the photoinitiator is one or more of a benzoin, aryl ketone, α-amino ketone, mono- or bis(acyl)phosphine oxide, benzoin alkyl ether, benzil ketal, phenylglyoxalic ester or derivatives thereof, oxime ester, per-ester, ketosulfone, phenylglyoxylate, borate, and metallocene.

10. The photocurable ink of claim 1 wherein the photoinitiator is present in an amount of a molar ratio to the organic phosphite of at least 0.5:1 and up to and including 50:1.

11. The photocurable ink of claim 1 further comprising a photosensitizer for the photoinitiator that is selected from the group consisting of ketocoumarins, benzophenones, xanthones, thioxanthones, arylketones, and polycyclic aromatic hydrocarbons.

12. The photocurable ink of claim 11 wherein the molar ratio of the photoinitiator to the photosensitizer is at least 1:1 and up to and including 100:1.

13. The photocurable ink of claim 1 wherein the total amount of photoinitiators is generally at least 2 weight % and up to and including 80 weight %, based on the total photocurable ink weight, and the molar ratio of organic phosphite to photoinitiator is at least 0.5:1 and up to and including 50:1.

14. The photocurable ink of claim 1 wherein the photocurable compound is an acrylate.

15. The photocurable ink of claim 1 wherein the aldehyde is an alkyl or aryl aldehyde having one or more aldehyde moieties and a molecular weight of less than 500.

16. The photocurable ink of claim 1 further comprising a colorant dispersing aid.

17. A method of applying an ink comprising:
providing the photocurable ink of claim 1,
curing the photocurable ink by irradiating it with curing radiation, and
before or during curing, applying the photocurable ink to a substrate.

18. The method of claim 17 wherein the photocurable ink is only partially cured with the curing radiation before application to the substrate.

19. The method of claim 17 wherein the photocurable ink is applied to the substrate before any curing.

20. The method of claim 17 that is carried out in the presence of oxygen.

21. The method of claim 17 wherein the photocurable ink comprises:
a colorant dispersed within a solvent,
an alkyl or aryl aldehyde having one or two aldehyde moieties per molecule and a molecular weight of less than 500,
an organic phosphite that is represented by the following Structure (I) or (II):
(R′O)₃P (I)
wherein the multiple R′ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or two R′ groups can form a cyclic aliphatic ring or fused ring system, 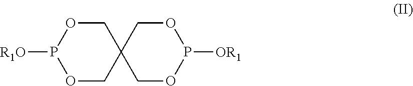
wherein the two R₁ groups are the same or different substituted or unsubstituted alkyl groups or HO[{CH(R)}ₓO]_{y} groups wherein the multiple R groups are the same or different and can be hydrogen atoms or substituted or unsubstituted alkyl groups, or the two R₁ groups can form a substituted or unsubstituted cyclic aliphatic ring or fused ring system, and
x is a number at least 2 and up to and including 20, and y is at least 1 and up to and including 20,
a photoinitiator is one or more of a benzoin, aryl ketone, α-amino ketone, mono- or bis(acyl)phosphine oxide, benzoin alkyl ether, benzil ketal, phenylglyoxalic ester or derivatives thereof, oxime ester, per-ester, ketosulfone, phenylglyoxylate, borate, and metallocene,
a photosensitizer for the photoinitiator that is selected from the group consisting of ketocoumarins, benzophenones, xanthones, thioxanthones, arylketones, and polycyclic aromatic hydrocarbons, and
a photocurable compound that is an acrylate.
